(19) United States
(12) Patent Application Publication
(10) Pub. No.: US 2023/0032383 A1
(43) Pub. Date: Feb. 2, 2023

(54) APPARATUS AND SYSTEM FOR USE WITH AN OPERATION

(71) Applicant: SYSTEMS WITH INTELLIGENCE INC., Mississauga (CA)

(72) Inventors: Fausto Della ROVERE, Mississauga (CA); Angelo RIZZO, Mississauga (CA); John NAM, Mississauga (CA); Richard HARADA, Mississauga (CA); Zachary VOGELHUT, Mississauga (CA); Raymond ALLEN, Mississauga (CA); Haoyue PENG, Mississauga (CA)

(73) Assignee: SYSTEMS WITH INTELLIGENCE INC., Mississauga, ON (CA)

(21) Appl. No.: 17/263,343

(22) PCT Filed: Jun. 9, 2020
(86) PCT No.: PCT/CA2020/050787

§ 371 Date: Jan. 26, 2021

Related U.S. Application Data
(60) Provisional application No. 63/022,787, filed on May 11, 2020.
(60) Provisional application No. 63/014,460, filed on Apr. 23, 2020.

(51) Int. Cl. H04N 7/18; H04N 5/232; H04W 4/38

(52) U.S. Cl. CPC H04N 7/181; H04N 5/232061; H04N 5/23216; H04W 4/38; H04W 84/20

(57) ABSTRACT

The operation has a plurality of points, each associated with a slave device, the devices being part of a SCADA network that includes a computer. The apparatus comprises: modules each including a sensor having a thermal imager and a transceiver coupled to the sensor to receive data and adapted for cellular communication; and functionality adapted to receive information via cellular network and to communicate with the SCADA. The functionality is couplable to the SCADA as a device and configured such that data delivered from the sensor to the transceiver is delivered as if from multiple points. The system comprises: a repository; a computer adaptation configured to permit conditions to be set which trigger alerts including a DNP point and a time stamp; and a further adaptation which, responsive to an alert, fetches from the repository an image file associated with the point and the stamp, and displays the image.

### FIELD

The invention relates to the field of facility automation.

### BACKGROUND

Sensor and automation technology improves yearly and older industrial facilities often lack sensing and automation capacity in areas that would routinely be remotely monitored and controlled in a newly-built facility.

### SUMMARY OF THE INVENTION

Forming one aspect of the invention is apparatus for use with operation having a plurality of points, each point associated with a respective one of a plurality of slave devices, the slave devices being coupled to one another as part of a SCADA network, the SCADA network being defined in part by a computer, the apparatus comprising:
a plurality of modules, each module including a sensor and a transceiver, the transceiver coupled to the sensor to receive data therefrom and adapted for communication via a cellular network; and
computing functionality adapted to receive information via a cellular network and to communicate with the SCADA system,
wherein the sensor is defined at least in part by a thermal imager.

According to another aspect of the invention, the sensor can be defined at least in part by a video imager.

According to another aspect of the invention:
the facility has areas of special interest imaged by the thermal imager and has areas imaged by the thermal imager not of special interest; and
a frequency of transfer of thermal data associated with the areas of special interest is higher than a frequency of transfer of thermal data with the areas not of special interest.

A system for use with the apparatus forms another aspect of the invention. This system comprises a GUI for selecting one or more areas of interest in the thermal image.

According to another aspect of the invention, the areas of interest imaged by the thermal imager can be selected by the GUI with reference to the video image.

According to another aspect of the invention, the computing functionality can be coupled to the SCADA system in the manner of a device and be configured such that data delivered from the sensor to the transceiver is delivered as if from a plurality of points.

According to another aspect of the invention, the computer:
can be adapted to permit conditions to be set which trigger the production of alerts, such alert including a DNP point and a time stamp; and
can have a program which, in response to an alert including a DNP point and a time stamp, fetches from the computing facility a photo associated with the DNP point and the time stamp, and causes the photo to be displayed.

Forming another aspect of the invention is a system for use with an operation having a plurality of points, each point associated with a respective one of a plurality of slave devices, the slave devices coupled to one another as part of a SCADA network, the SCADA network being defined in part by a computer. This system comprises:
a repository for image files;
an adaptation to the computer, the adaptation being configured to permit conditions to be set which trigger the productions of alerts, such alert including a DNP point and a time stamp; and
a further adaptation to the computer which, in response to an alert including a DNP point and a time stamp, fetches from the repository an image file associated with the DNP point and the time stamp, and causes the image to be displayed.

Advantages, features and characteristics of the invention will become evident upon a review of the following detailed description, with reference to the appended drawings, the latter being briefly described herein below.

### BRIEF DESCRIPTION OF THE DRAWINGS

FIG. 1 is a schematic view of a prior art electrical substation;

FIG. 2 is a view of apparatus according to a non-limiting embodiment of the invention;

FIG. 3 is a view of a system according to a non-limiting embodiment of the invention;

FIG. 4 is a view of the apparatus of FIG. 2 and the system of FIG. 3 in use with the substation of FIG. 1;

FIG. 5 is a view taken from an optical imager;

FIG. 6 is a view taken from a thermal imager with areas of special thermal interest defined thereon;

FIG. 7 is a stylized view of the structure of FIG. 4;

FIG. 8 is a view, similar to FIG. 4, wherein the SCADA network includes a digital video server, an archive server and a plurality of cameras;

FIG. 9 is a view, similar to FIG. 8, wherein the gateway, wireless sensors and cloud server are omitted;

FIG. 10 shows an example of a device 22 and the label affixed thereto;

FIG. 11 is a screen shot of a functionality according to an embodiment of the invention showing an example device inventory;

FIG. 12 is a screen shot of a functionality according to an embodiment of the invention showing area of interest definition; and

FIG. 13 is a screen shot of a functionality according to an embodiment of the invention showing a UI for parameter setting in respect of an area of interest.

### DETAILED DESCRIPTION

### Use Case

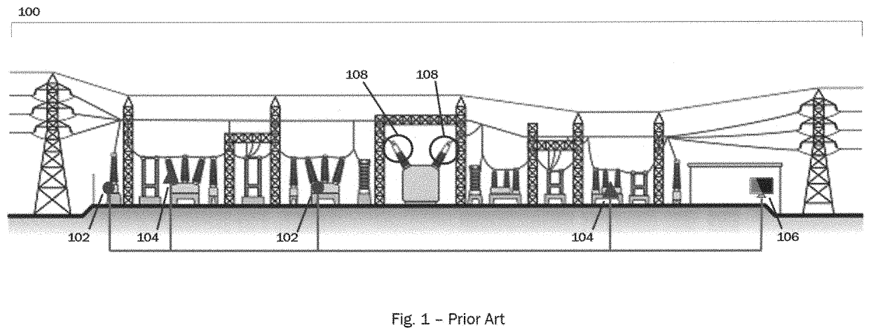

Described in detail below is an apparatus according to an embodiment of the invention and a system forming another embodiment of the invention adapted for use with the apparatus, but as an initial matter, it should first be understood that the apparatus and system are for use with:
as shown in FIG. 1, a facility 100 having a plurality of sensors 102 and a plurality of controllers 104 forming part of a SCADA network that includes a computer 106 and further having a plurality of areas of special interest 108;
supplemental sensors; and
supplemental controllers.

### Facility

The facility 100 is an existing electrical substation.

The plurality of sensors and plurality of controllers are tied to a myriad of functions carried out by and in the facility.

The SCADA network is arranged such that each sensor and each controller forms part of a slave device to which a point, or a plurality of points, in the SCADA network is associated.

The areas of special interest are areas that exhibit a thermal behavior that is probative of impending failure.

### Supplemental Sensors

The sensors are conventional sensors adapted for measuring conditions associated with the facility, for example, temperature, voltage, water level, amperage, humidity, radiation, vibration, acoustic, DGA, Partial Discharge, etc., and as such are not separately shown.

### Supplemental Controllers

The supplemental controllers are conventional controllers adapted for controlling operations within the facility in response to a control signal and as such are not separately shown.

### Apparatus

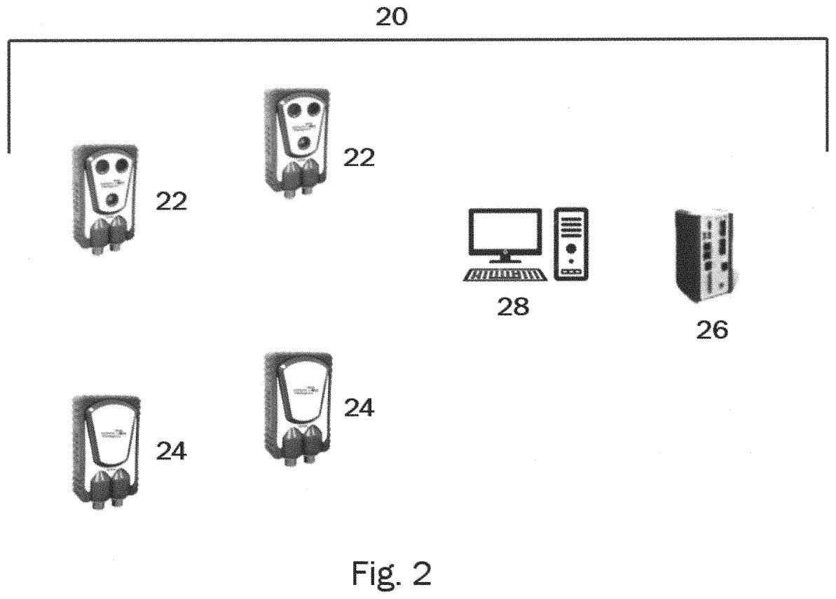

As shown in FIG. 2, the apparatus 20 comprises modules 22, 24, a computing functionality 26 and a computer adaptation 28.

The modules are of two types 22, 24. Type 24 is adapted for collecting data from the supplemental sensors via a Serial RS485 Modbus connection. Type 24 can capture data from up to 32 devices and can handle up to 64 Modbus points. Points can be any data captured by a third party sensor. Both types 22, 24 can be used to collect status from 2 Digital Inputs and are adapted to deliver a control signal through a digital output. Both types 22, 24 are adapted to collects GPS location data. One type 22 further collects data from an onboard thermal imager and a video imager. The thermal image contain per pixel temperature of the entire image. The polling rate for the video capture and thermal capture can be varied, both for the entire image and areas of interest. Both types include a wireless transceiver for transmitting the received data via a cellular network and for receiving data via a cellular network. Both types further have a processor adapted to produce the control signal in response to data received via the cellular network.

The computing functionality 26 is an electronic gateway adapted to receive information from the cellular network via the internet, is adapted to couple to a SCADA system in the manner of a ‘single’ DNP slave device (i.e. Ethernet LAN or serial) and is configured such that data delivered from the supplemental sensors to the transceivers is delivered as if from a plurality of points, i.e. converts data and alarm events into DNP protocol.

The computer adaptation 28 includes an adaptation to the computer of the SCADA system, namely, a program, which, in response to an alert including a DNP point and a time stamp, fetches a photo associated with the DNP point and the time stamp, and causes the photo to be displayed. For greater certainty, in this embodiment, 28 is a program that is installed on the SCADA server of a customer and launched thereby.

### System

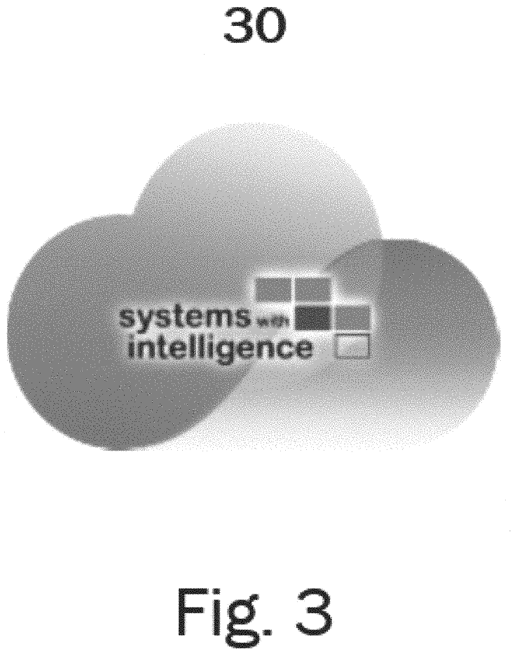

This system is indicated in FIG. 3, will be understood to be for use with the apparatus 20 and to comprise a cloud server 30 that, inter alia:
receives and archives data sent to and from the transceivers 22, 24;
communicates with the gateway 26;
provides a dashboard to users, accessible anywhere using a web browser, allowing visibility to the data and allowing alarms/events to be set;
notifies users of alarms/events by email;
communicates with the modules to permit frequency of data transfer to be set;
provides a GUI for selecting one or more areas of interest in the thermal image with reference to the video image;
communicates with the gateway 26 to permit remote reprogramming, i.e. serves as the user interface for gateway 26;
communicates with the computing functionality to permit conditions to be set remotely;
in response to a call from the computer adaption via computing functionality including a point and a time stamp, delivers a photo;
communicates with the modules to provide remote programming; and
communicates with the modules to provide location data.

### Deployment

Use of apparatus 20 and system 30 involves the steps that follow.

### Deployment of Supplemental Sensors

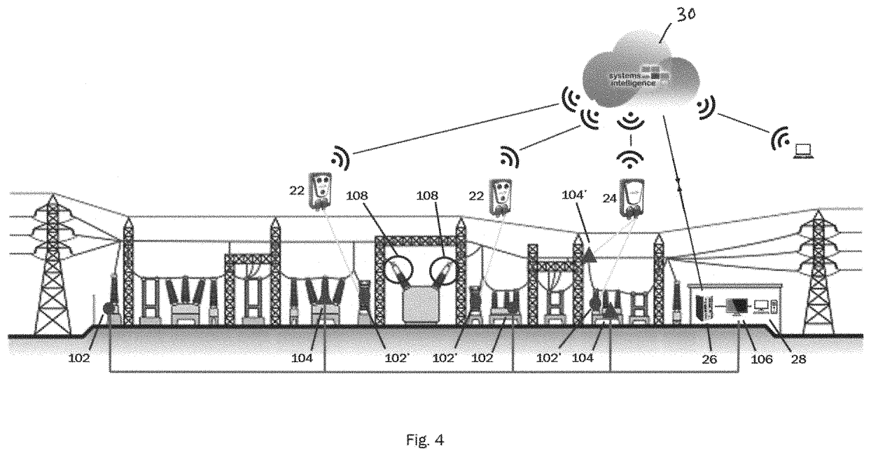

In this step, supplemental sensors 102′ are deployed throughout facility 100 as desired, as shown by way of example in FIG. 4.

In this regard, it will be appreciated that sensor and automation technology improves yearly and that older industrial facilities often lack sensing capacity in areas that would routinely be monitored in a newly-built facility. Deployment of sensors is a matter of routine to persons of ordinary skill in the art of facility design and as such, further detail is neither provided nor required.

### Deployment of Supplemental Controllers

In this step, supplemental controllers 104′ are deployed throughout the facility as desired, as shown by way of example in FIG. 4. In this regard, it will be appreciated that sensor and automation technology improves yearly and that older industrial facilities often automation capacity in areas that would routinely be automated in a newly-built facility. Deployment of controllers is a matter of routine to persons of ordinary skill in the art of facility design and as such, further detail is neither provided nor required.

### Apparatus Deployment

In this step, and as shown in FIG. 4,
modules 22,24 are deployed throughout the facility such that
   areas of special thermal interest 108 are in view of the imaging sensors of modules of the first type 22
   each supplemental controller 104′ is coupled to a module 22 or 24
   each supplemental sensor 102′ is coupled to a module 24.
the computer adaption 28 is loaded onto the computer 106 of the existing SCADA system; and
the computing functionality 26 is connected to the SCADA computer—inside the security perimeter of the faciliyt—and also to the internet and coupled to the SCADA network in the manner of a ‘single’ DNP slave device.

Persons of ordinary skill will readily appreciate that coupling sensors and controllers to the digital inputs and outputs of the modules 22,24 is a matter of routine and as such, further detail is neither provided nor required. Functionalizing the devices 22,24 requires:
as a preliminary step, an enrolment process, wherein rights to the cloud computing functionality are obtained, user privileges are defined and a database is created for the facility; and
associating the devices with the facility database.

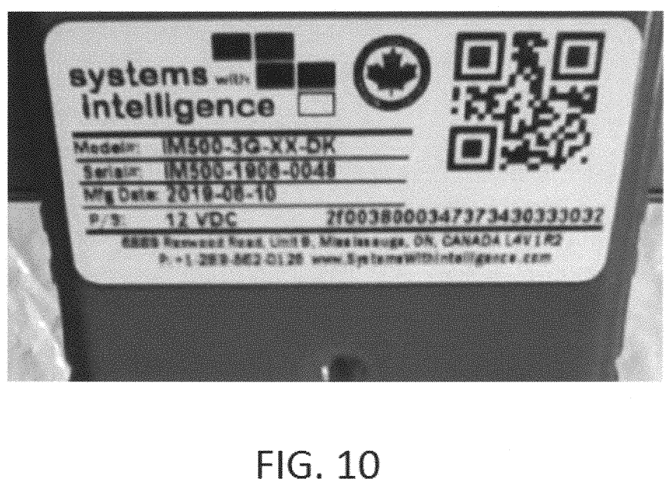

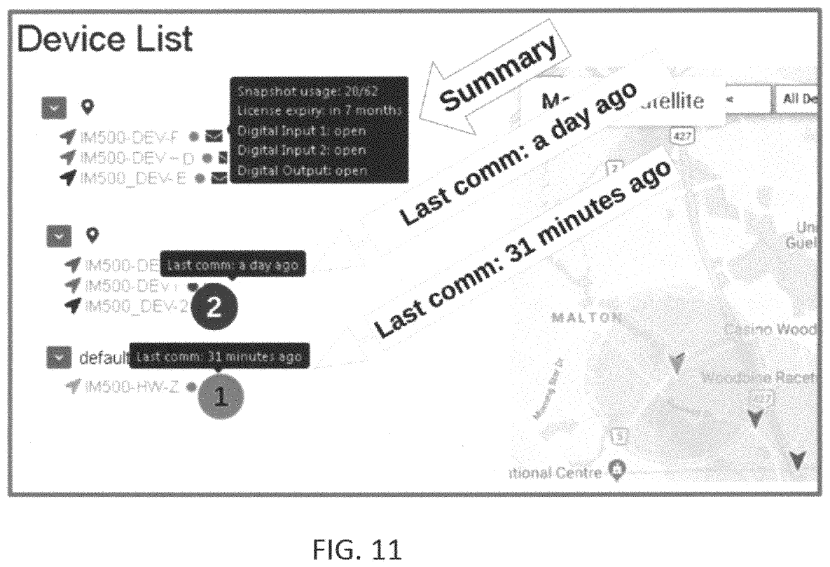

The former of course is all very routine and as such not described herein. Respecting the latter, in the present embodiment, each device carries a label which in a QR code carries a unique identifier; scanning the QR code automatically associates the device with the facility such that, when the facility is viewed using the functionality, the device appears in the inventory of devices. FIG. 10 shows an example of a label. FIG. 11 shows an example of an inventory.

### Image Tuning

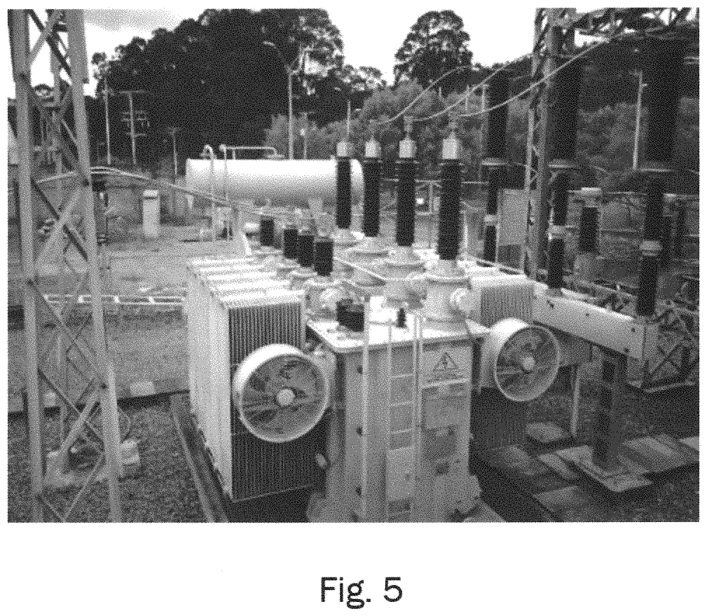

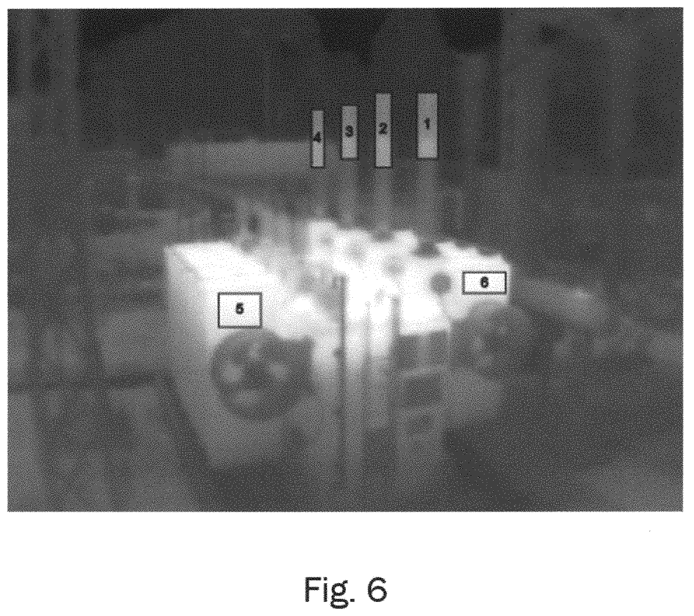

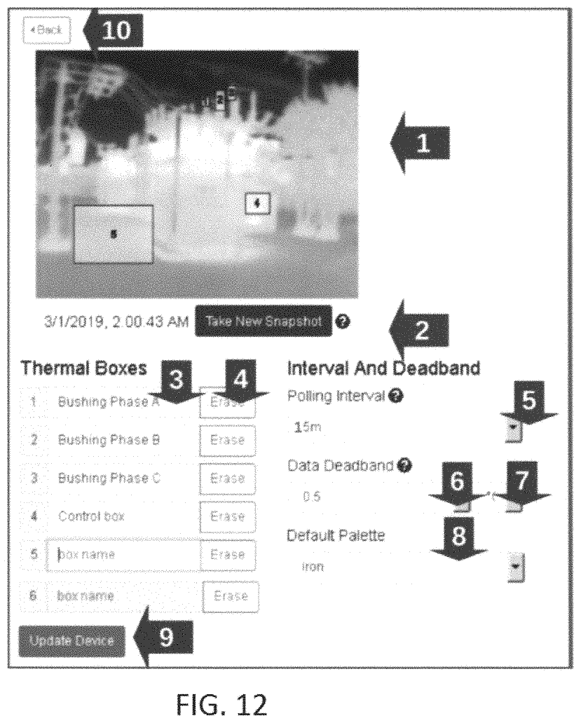

In this step, areas of special interest in the thermal images are selected with the GUI. In this regard, it will be appreciated that modules 22 of the first type will be orientated towards the areas of thermal interest 108 but that the image captured by the thermal and optical imagers will typically include many areas that are of no particular thermal interest; the GUI is used to select those areas. The manner of selection will be better understood with reference to FIG. 5 and FIG. 6. FIG. 5 is a representative image taken by an optical sensor of one of modules 22. FIG. 6 is a representative image taken by the accompanying thermal sensor. The images will be seen to be generally similar, since they are taken by imaging devices only a few centimeters apart from one another. These images are made available to an operator on a computer who selects a rectangular area on the screen of the thermal image by clicking-and-dragging a cursor and using the optical image as a reference; the area so selected appears on the thermal image as a labelled box, as indicated in FIG. 6. FIG. 12 shows a user interface associated with this embodiment. Herein, areas of interest are referred-to as “Thermal Boxes”. Up to 6 Thermal Boxes can be defined, through the click-and-drag method.

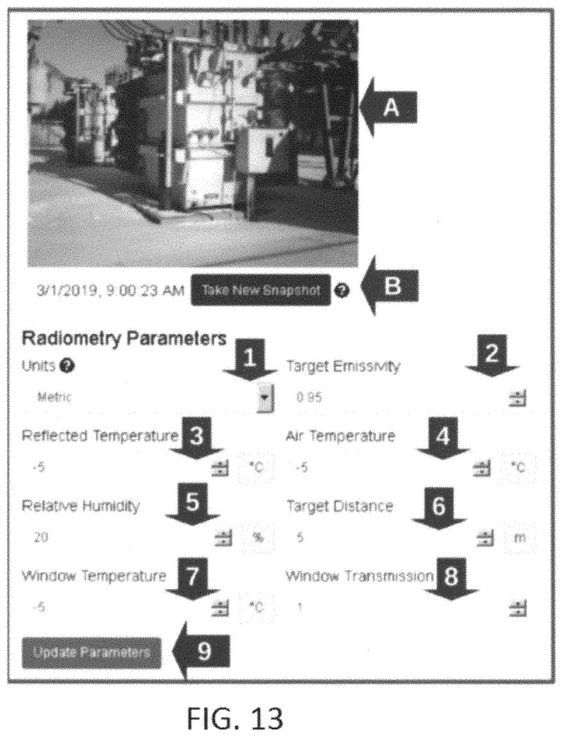

Once a box has been selected and defined, it can be given a name, such as Bushing Phase A. Radiometry parameters, such as emissivity, reflected temperature, etc., also need to be set, as shown in FIG. 13, to ensure that the thermal image is useful for the particular situation, i.e., setting a reflected temperature that is significantly lower than the typical background temperature, and providing a relatively narrow scale, will produce a thermal image that is completely washed out.

### Frequency Tuning

In this step, the frequency of data transfer between the modules and the SCADA system is set, based upon, inter alia, the nature of the point and the criticality of the information. For example, only, the frequency of transfer of thermal data associated with the areas of special interest will typically be higher than a frequency of transfer of thermal data with the areas not of special interest. Returning to FIG. 12, a GUI for setting frequency of transmission (polling interval) for areas of thermal interest will be shown, but persons of ordinary skill will readily appreciate that thresholds could be selected other ways. Threshold selection of this type is a matter of routine to persons of ordinary skill in the art of facility design and as such, further detail is neither provided nor required.

### Set Point Definition

In this step, conditions are set which trigger the production of alerts, such alert including a DNP point and a time stamp. Alert programming is a matter of routine to persons of ordinary skill in the art of facility design and as such, further detail is neither provided nor required.

### Automation Reconfiguration

In this step, the SCADA system is reconfigured to reflect the devices and points added by virtue of the apparatus. SCADA configuration is a matter of routine to persons of ordinary skill in the art of facility design and as such, further detail is neither provided nor required.

### Use

In use, information passes between the SCADA system and the modules via the cellular network to permit the facility to operate as if it had been constructed with the supplemental sensors and supplemental controllers connected to the SCADA system in the same manner as the sensors and controllers.

At the same time, the system provides significant new functionality:
operators and management can view the thermal and optical images captured by the modules through a secure portal; and
in the event that an alert is triggered, the program fetches from the computing facility a photo associated with the DNP point and the time stamp and causes the photo to be displayed.

### Data Communication Path

An overview of the data communication path is as follows:

### Modules 22 and 24

collect data (i.e. temperature, DIO, thermal/visual images, other sensors etc . . . )
send collected data securely to functionality 30 via public cellular network available in the region

### Functionality 30

archives the data into databases
performs user defined analytics using the data collected (i.e. thermal alarms, sensor alarms etc.
notifies the users via email of any alarm/events
provides a frontend webpage/dashboard that displays the data (i.e. chart, status display, images, historical data/images etc.)
frontend webpage/dashboard that allows user to define Region of Interest (ROI) for the thermal data (for IM500), set reporting rate, any alarm/analytic rules and other management and device setup features
used to setup DNP3 (or DNP) to be used with 26
   DNP is an industrial communication protocol
   DNP setup is done via webpage of 30
   DNP Points setup
      Analog DNP Point=numerical data collected (i.e. temperature, voltage, current etc.)
      Binary DNP Point=event generated (i.e. alarm, DIO event)
   communicates with 26 and set it up for DNP accordingly as per user setup
User can login to the webpage of 30 from anywhere via Internet to view the dashboard, (requires PC/Laptop+Browser: Chrome, Firefox, Edge etc.)

### Gateway 26

communicates with 30 via internet
retrieves and converts the data stored in 30 into DNP data
3^{rd} party DNP server software (i.e. SCADA) communicates with 30 and gets data/event reporting
26 communicates to SCADA via internal communication network such as LAN

### Adaptation 28

Retrieves alarm/event images when so programmed
For example: unit #5, thermalbox1, maximum temperature >50 C will trigger an alarm and it will take snapshot images. This alarm is programmed as a Binary DNP Point #10.
   Temp >50 C and the alarm above is triggered
   Binary DNP point #10 goes from 0->1 (or FALSE->TRUE)
   The 3rd party SCADA will get this result from 26
   The SCADA can then pass the DNP point # and timestamp to 28 via command line
   28 will communicate to 26 which will communicate to 30 and retrieve the correct Alarm Image.

### Advantages

Persons of ordinary skill will readily appreciate the foregoing has significant advantage, in that it:
allows for the SCADA network of an existing facility to be upgraded without the cost and complexity typically associated with SCADA wiring upgrades;
provides access to imagery at relatively low cost, given that the cellular network is not heavily used

### Further Embodiments

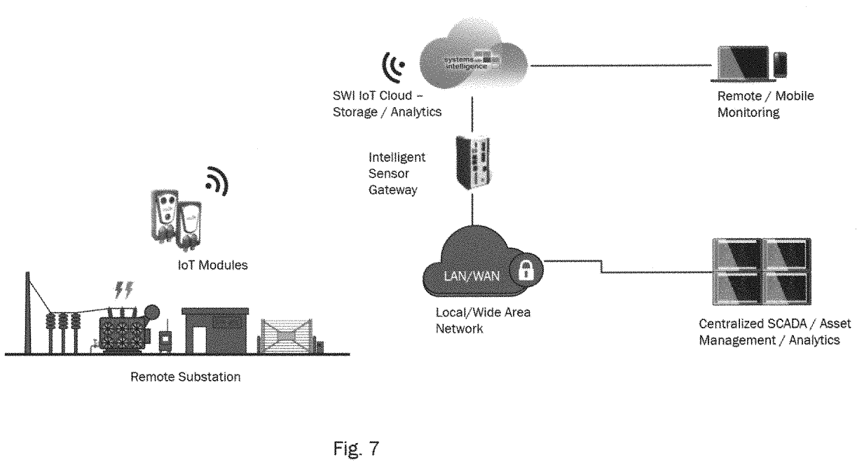

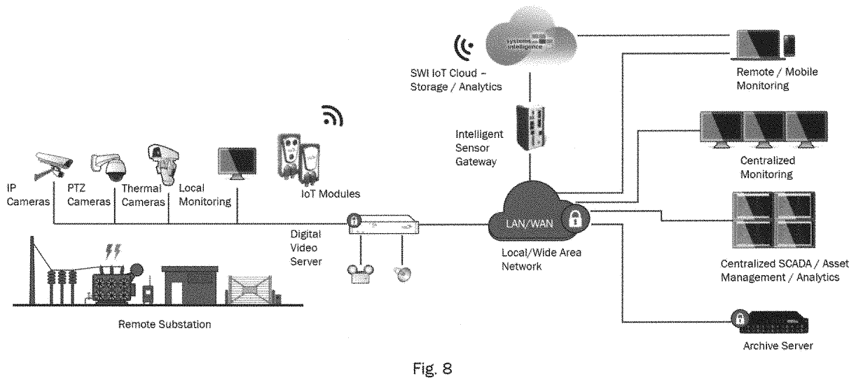

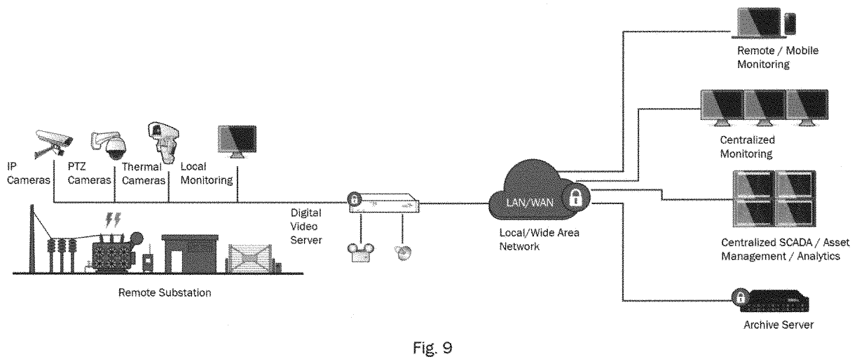

Persons of ordinary skill will readily appreciate that the computing adaptation which provides for the display of images as shown in FIG. 4 and described hereinbefore need not be so embodied. For example, whereas the described adaption fetches photographs, the adaptation could equally fetch video files. Further, whereas the described adaptation fetches from a cloud server, the file to be used for the display could be collected from any repository, such as a local server connected to the SCADA network (LAN or WAN). Further, whereas the described adaptation contemplates images captured from sensors unrelated to the SCADA network otherwise than via a cellular connection, the images could be captured by sensors hard wired in the SCADA WAN/LAN. FIG. 7 is a stylized view of the system of FIG. 4. FIG. 8 is a view, similar to FIG. 7, wherein the SCADA network further includes a variety of cameras, digital video servers and an archive server to which images are stored and from which images are fetched. FIG. 9 is a view similar to FIG. 7 wherein the cloud and wireless sensors are omitted.

### Variations

Whereas specific embodiments are shown and described, variations are possible, without limitation:
whereas an electrical substation is mentioned, the apparatus and system could be used in other applications;
the areas of special interest are indicated to be areas of special thermal interest, but areas of special interest are not required;
the special interest need not be thermal;
the modules need not all have outputs and inputs, nor do they need GPS;
the modules could communicate with the cellular network or LAN/WAN via a wireless base station;
the computer adaption could be omitted;
the computing functionality might coupled to the SCADA system otherwise than as a device;
the points need not all be associated with slave devices in the SCADA network;
the computing functionality could be partly or fully defined by a cloud server;
the GUI could be omitted and areas of thermal interest could be selected otherwise;
the cloud server could be omitted and a physical server of similar functionality could be physically coupled or otherwise form part of computing functionality.

Accordingly, the invention should be understood to be limited only by the accompanying claims, purposively construed.

1. Apparatus for use with operation having a plurality of points, each point associated with a respective one of a plurality of slave devices, the slave devices coupled to one another as part of a SCADA network, the SCADA network being defined in part by a computer, the apparatus comprising:
a plurality of modules, each module including a sensor and a transceiver, the transceiver coupled to the sensor to receive data therefrom and adapted for communication via a cellular network;
computing functionality adapted to receive information via a cellular network and to communicate with the SCADA system; and
wherein the sensor is defined at least in part by a thermal imager.

2. Apparatus according to claim 1, wherein the sensor is defined at least in part by a video imager.

3. Apparatus according to claim 2, wherein:
the facility has areas of special interest imaged by the thermal imager and has areas imaged by the thermal imager that are not of special interest; and
a frequency of transfer of thermal data associated with the areas of special interest is higher than a frequency of transfer of thermal data with the areas not of special interest.

4. A system for use with the apparatus of claim 3, comprising:
a GUI for selecting one or more areas of interest in the thermal image.

5. A system according to claim 4, wherein the areas of interest imaged by the thermal imager are selected by the GUI with reference to the video image.

6. Apparatus according to claim 1, wherein the computing functionality is coupled to the SCADA system in the manner of a device and is configured such that data delivered from the sensor to the transceiver is delivered as if from a plurality of points.

7. Apparatus according to claim 1, wherein the computer
is configured to permit conditions to be set which trigger the productions of alerts, such alert including a DNP point and a time stamp; and
has an adaptation which, in response to an alert including a DNP point and a time stamp, fetches from the computing facility a photo associated with the DNP point and the time stamp, and causes the photo to be displayed.

8. A system for use with an operation having a plurality of points, each point associated with a respective one of a plurality of slave devices, the slave devices coupled to one another as part of a SCADA network, the SCADA network being defined in part by a computer, the system comprising:
a repository for image files;
an adaptation to the computer, the adaptation being configured to permit conditions to be set which trigger the productions of alerts, such alert including a DNP point and a time stamp; and
a further adaptation to the computer which, in response to an alert including a DNP point and a time stamp, fetches from the repository an image file associated with the DNP point and the time stamp, and causes the image to be displayed.
